(19) United States
(12) Patent Application Publication
(10) Pub. No.: US 2019/0178086 A1
(43) Pub. Date: Jun. 13, 2019

(54) METHOD FOR ADDITIVE MANUFACTURING OF A COMPONENT AND COMPONENT MANUFACTURED BY THAT METHOD

(71) Applicant: GENERAL ELECTRIC TECHNOLOGY GMBH, Baden (CH)

(72) Inventors: Martin FRANKE, Fuerth (DE); Simon EICHLER, Fuerth (DE)

(21) Appl. No.: 16/321,239

(22) PCT Filed: Jul. 25, 2017
(86) PCT No.: PCT/EP2017/068795

§ 371 Date: Jan. 28, 2019

(30) Foreign Application Priority Data
Jul. 28, 2016 (DE) 10 2016 213 917.7

(51) Int. Cl. F01D 5/14; B33Y 10/00; B33Y 40/00; B23K 26/342; B23K 26/142; F01D 5/18

(52) U.S. Cl. CPC F01D 5/147; B33Y 10/00; F01D 5/185; B23K 26/342; B23K 26/142; B33Y 40/00

(57) ABSTRACT

A method according for the manufacturing of a component in which walls surround a cavity and the cavity is accessible through at least one aperture formed in one of the walls, according to the following steps: manufacturing of the component by an additive method, in which metallic powder particles are applied to a support layer by layer in a process chamber, and the walls are each manufactured after the application of a layer of the metallic powder particles by melting by means of an energy beam along a predetermined path, connection of the aperture to a flushing device, supply of a liquid etchant into the cavity by means of the flushing device, selective dissolution by the etchant of power particles connected to each other only via sinter necks and/or fusible links and flushing of the etchant and the dissolved powder particles out of the cavity.

### BACKGROUND OF THE INVENTION

The invention relates to a method for manufacturing a component in which walls surround a cavity and the cavity is accessible through at least one aperture formed in one of the walls.

For the manufacturing of components with complex geometries, which have e.g. cavities, a lattice structure, or another complicated three-dimensional structure, additive manufacturing methods are used. In an additive manufacturing method, a component is manufactured in layers by the addition of material. The added material is melted, welded or sintered along a predefined path under the influence of heat with the material located underneath. The material is usually in powder form and can be melted and/or sintered in layers with the material located underneath by means of an energy beam, in particular by means of an electron beam or by means of a laser beam. Such additive preparation methods are particularly suitable for the manufacturing of metallic components.

An additive method for manufacturing a component having a cavity is described in DE 10 2009 048 665 A1. The component is manufactured in layers by melting a first powder layer locally by means of an energy beam to form a first layer, and thereafter further powder coatings are applied layer by layer and melted locally.

EP 2 319 641 A1 describes an additive method in which a metallic material in powder form is sintered by an energy beam. Examples of such manufacturing methods are selective electron beam melting (SEBM), selective laser melting (SLM), and direct metal laser sintering (DMLS).

DE 10 2011 101 857 A1 explains that drain holes are provided for the manufacturing of components with closed cavities, through which the non-consolidated powder material trapped in the cavities can trickle out. The drain holes are closed by a plug after emptying the cavities. To improve the accessibility of the cavities, it is proposed to break the component along a break line into at least two fractional parts and to reassemble the fractional parts after removing the powder.

In the manufacturing of a metallic component with a high melting point by means of an additive method, metallic powder is first heated in a process chamber, e.g. to a temperature of 1,000° C. By means of the energy beam, metallic powder particles are heated in the process chamber to temperatures above the melting temperature of the metal, which can be e.g. 3,000° C. The molten regions form the component structure after cooling and solidification. Powder particles outside the melting zones are so strongly heated by the energy beam that they are only connected to one another by means of “material bridges” such as fusible links and/or sinter necks.

### BRIEF DESCRIPTION OF THE INVENTION

The molten and/or sintered particles, which are connected to one another via fusible links and/or sinter necks, remain in the cavity after manufacturing of the component. Depending on the manufacturing method, they can also fill the entire cavity. For many applications, however, it is desirable or required that the cavity be free of such molten and/or sintered structures, e.g. if a gas or liquid is to be passed through the cavity during operation.

The object of an embodiment is to provide a simple and cost-effective method for removing sintered and/or molten particles from the cavity of an additively manufactured component.

In order to achieve this object, a method with the features of claim 1 is proposed.

The method according to the invention for the manufacturing of a component in which walls surround a cavity and the cavity is accessible through at least one aperture formed in one of the walls, according to the following steps: manufacturing the component by an additive method in which metallic powder particles are applied in layers in a process chamber on a support, and the walls are manufactured each time after applying a layer of metallic powder particles by melting with an energy beam along a predetermined path; connecting the aperture to a flushing device; feeding a liquid etchant into the cavity by means of the flushing device, using the etchant, selectively dissolving powder particles which are connected to each other only by way of sinter necks and/or fusible links; and flushing the etchant and the dissolved powder particles out of the cavity.

An embodiment is based on the discovery that so-called “sinter necks” and/or fusible links form between adjacent powder particles. A sinter neck is a material bridge which is formed by a material transfer caused by diffusion that bonds two powder particles together firmly. A fusible link is formed by the solidification of molten material. There is the possibility that the powder particles are molten incompletely so that the basic shape of the powder particles remains. Local material bonds form between adjacent powder particles as a result of local melting of the surface of the powder particles. These local fusible links cause a similar solidification of the powder particles as in sintering. A diameter of a sinter neck and/or a fusible link is always smaller than a further diameter of the powder particles connected via the sinter neck. The powder particles present in the cavity, at least partially connected to each other by sinter necks and/or fusible links, form an open-pored porous structure, which can be passed through with an etchant. By introducing the etchant into the cavity through the aperture or a perforation in a wall, the sinter necks and/or fusible links can be at least partially dissolved. The selectively dissolved powder particles can then be flushed out of the cavity. The method according to the invention has the advantage that the liquid etchant also reaches geometrically complicated cavities, e.g. multiply angled or curved cavities as well as grid structures.

The etchant introduced into the cavity destroys the porous structures. Small substructures or dissolved powder particles form, which can be flushed out with the etchant or another liquid. Alternatively or additionally, the substructures can also be discharged mechanically by shaking (vibration).

A variant of the method according to the invention provides that, during the manufacture of the component, a connection linked to the aperture is formed for the detachable connection to a line of the flushing device. The connection can e.g. be designed as a pipe socket which allows the attachment of a line. Alternatively, the connection can also be designed as a flange. In addition, further coupling possibilities are of course conceivable, e.g. the connection can be provided with a thread in order to fasten a hose or line by means of a screw connection in order to supply the etchant.

In the method according to the invention, the molded-on connection be removed after flushing the dissolved powder particles. It is possible to remove the connection e.g. by a machining method such as sawing, milling or turning. Alternatively, the connection can also have a predetermined breaking point so that it can be broken off.

Within the scope of the invention, the flushing device comprises a pump. With the pump, the etchant can be pressed into the cavity with a predetermined pressure. The components of the rinsing device and, in particular, the pump are manufactured from a material resistant to the etchant, e.g. a plastic material.

It can also be provided that the dissolved powder particles are collected in a filter of the flushing device. This results in the advantage that the etchant can be recovered.

The method is particularly well suited to components having a first aperture and a second aperture, whereby the liquid etchant is fed into the cavity through the first aperture and removed through the second aperture. With a component assembled in this way, the etchant can be conveyed in a circuit through the flushing device.

It is also within the scope of the invention that metallic powder particles are removed from a plurality of cavity sections and/or hollow structures and/or ducts in the component. In an embodiment, an uncovered cavity section or duct is subsequently at least temporarily closed. A cavity section can be closed e.g. by means of a removable etchant-resistant adhesive or plastic, wax or a stopper. In this way, the liquid etchant can be introduced successively into a plurality of cavity sections. These can be e.g. cavity sections which form a duct for the passage of a fluid, in particular a gas or a liquid, in order to temper the component during operation, in particular to cool it.

In the manufacturing method according to the invention, an electron beam or laser beam is in an embodiment is used as the energy beam. Such energy beams are distinguished by a high energy density and allow the melting of the metallic powder particles.

In an embodiment, metallic powder particles of a nickel base alloy, a cobalt base alloy, a titanium base alloy, a copper alloy, steel or a combination thereof are used in the method according to the invention. Intermetallic compounds, in particular titanium aluminides, are also suitable.

In the method according to the invention, an acid or a lye is more particularly used as the liquid etchant. In particular, one of the following substances or a combination thereof may be used: Hydrochloric acid (HCl); hydrochloric acid (HCl)+hydrogen peroxide (H₂O₂); hydrochloric acid (HCl)+acetic acid (C₂H₄O₂); acetic acid (C₂H₄O₂)+perchloric acid (HClO₄); hydrochloric acid (HCl)+hydrogen peroxide (H₂O₂); nitric acid (HNO₃), more particularly in the following concentrations: 65%, 15%, 6%; acetic acid (C₂H₄O₂)+hydrochloric acid (HCl)+nitric acid (HNO₃); nitric acid (HNO₃)+acetic acid (C₂H₄O₂)+phosphoric acid (H₃PO₄); nitric acid (HNO₃)+hydrofluoric acid (HF); hydrofluoric acid (HF)+sulfuric acid (H₂SO₄); iron(III) nitrate (Fe(NO₃)₃)+acetic acid (CH₃COOH)+water (H₂O); iron (III) chloride (Fe(III)Cl₃) saturated+hydrochloric acid (HCl)+nitric acid (HNO₃); potassium hydroxide (KOH)+hydrogen peroxide (H₂O₂); potassium hydroxide (KOH)+hydrogen peroxide (H₂O₂)+water (H₂O); 25 Vol. % potassium hydroxide (KOH)+10 Vol. % hydrogen peroxide (H₂O₂)+65 Vol. % water (H₂O); sulfuric acid (H₂SO₄)+hydrochloric acid (HCl); nitric acid (HNO₃)+hydrochloric acid (HCl)+hydrofluoric acid (HF); sodium hydroxide (NaOH).

The indicated substances and compounds can be used at different concentrations. By heating the etchant, e.g. to a temperature in the range from 35° C. to 95° C., the dissolution of the sinter necks and/or the fusible links can be accelerated. By determining a specific concentration of the etchant, its effect can be adapted specifically to the respective application.

A further development of the method according to the invention provides that the powder particles, which form the porous structure and are only connected to one another via sinter necks and/or fusible links, are brought into contact with the etchant for a time of less than 1 minute to 20 minutes, and in an embodiment 1 minute to 10 minutes, This short time is sufficient to at least partially dissolve the sinter necks, i.e. the sintered material-bonding connections between the metallic powder particles and/or the fusible links, so as to ensure their mobility. The method according to the invention thus has the advantage of a short process duration. Since the liquid etchant also acts on the internal surfaces of the component, in particular on internal surfaces of the cavity, it is also advantageous to make these internal surfaces smooth.

In this context, it can be provided in the method according to the invention that the etchant is introduced into the cavity and/or remains there until 0.5 to 10% by weight, and more particularly <5% by weight, of the porous structure formed by the powder particles connected only via their sinter necks and/or fusible links is removed from the cavity. It is sufficient to dissolve this small portion of the porous structure so that it disintegrates into substructures and can be removed through a liquid stream.

The method according to an embodiment is performed in the process chamber with the use of an electron beam under a vacuum, as a result of which the contamination by oxygen or nitrogen can be reduced.

In the method according to the invention, the process chamber in an embodiment is heated to a temperature corresponding to at least 0.5 times the melting temperature of the metallic powder particles.

The method according to an embodiment is particularly suitable for the manufacturing and post-processing of a component of a gas turbine; in particular, the component manufactured by the method according to the invention can be a turbine blade. In addition, other components of a gas turbine can also be manufactured using the method according to the invention. Examples include stationary guide vanes or other components of a gas turbine exposed to high temperatures. The gas turbine can be designed as a stationary gas turbine or as an engine for an aircraft. In an embodiment, the gas turbine is a turbojet or a shaft turbine.

The invention also relates to a component, in particular a component of a stationary gas turbine or an engine for an aircraft, in particular a turbine blade, having at least one cavity. The component according to an embodiment is characterized in that it is manufactured using the described method.

### BRIEF DESCRIPTION OF THE DRAWINGS

In an embodiment explained in more detail below by means of exemplary embodiments with reference to the drawings. The schematic drawings show the following:

FIG. 1 shows an exemplary electron beam system for the additive manufacture of components;

FIG. 2 shows an exemplary detail of a wall of a manufactured component;

FIG. 3 shows an exemplary arrangement for performing the method according to the invention;

FIG. 4 depicts a graph of the mass loss over the etching time for a nickel base material;

FIG. 5 depicts a graph of the mass loss over the etching time for copper; and

FIG. 6 depicts a graph of the mass loss over the etching time for TiAl6V4.

### DETAILED DESCRIPTION OF THE INVENTION

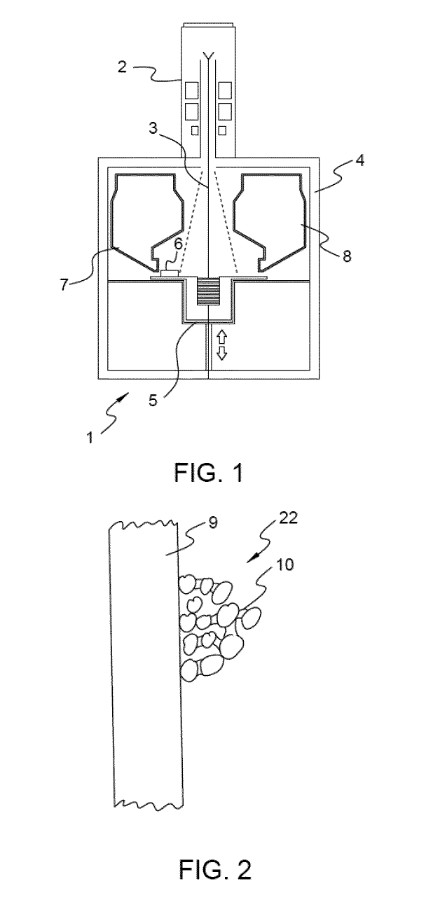

FIG. 1 shows an electron beam system 1 which is suitable for the additive manufacturing of components by selective electron beam melting. The electron beam system 1 comprises an electron beam tube 2 for creating an electron beam 3. A vertically movable support 5 is located in an evacuated process chamber 4. By means of a doctor blade 6, the metallic powder particles dispensed from powder containers 7, 8 are distributed on the support 5 so that a first powder layer is formed. The size of the metallic powder particles is in an embodiment 45 to 150 μm.

The interior of the process chamber is preheated to a temperature corresponding to e.g. 0.8 times the melting temperature of the metallic powder particles. The electron beam 3 striking the powder layer causes a further temperature increase and thus a local melting of the metallic powder particles. After solidification, a layer of the contour of the component to be manufactured is formed. The path of the electron beam is determined by a CAD model of the component to be manufactured. The CAD model includes the contours of the individual layers of the component. By moving the focused electron beam along a defined contour, a layer is formed. Subsequently, the vertically movable support 5 is lowered according to the thickness of the layer to be manufactured, and a powder layer is applied again. In this way, the component to be manufactured is created layer by layer. A defocused beam is used for preheating (sintering) and a focused beam is used for melting.

In the method, however, those metallic powder particles are also heated which are not directly impacted by the focused electron beam. In particular in the vicinity of molten regions, sinter necks are formed between the powder particles. Molten bridges can be formed in or at the edge of molten regions. A largely open-pored porous structure is formed there. Such a porous structure can also fill a cavity in the component completely.

FIG. 2 shows a detail of a wall 9 of a component to be manufactured, in which a porous structure 22 connected by sinter necks 10 is located. Such a porous structure can be easily removed at an external side of the component. However, such a porous structure also arises in the interior of the component to be manufactured, in particular also in a cavity surrounded by walls 9. Such cavities are usually assigned specific function. For example, they are used for the passage of a gas or liquid during the operation of the component. In order to ensure the correct functioning of the component, it is necessary to remove the porous structure 22 connected by means of sinter necks 10 and, if appropriate, by fusible links.

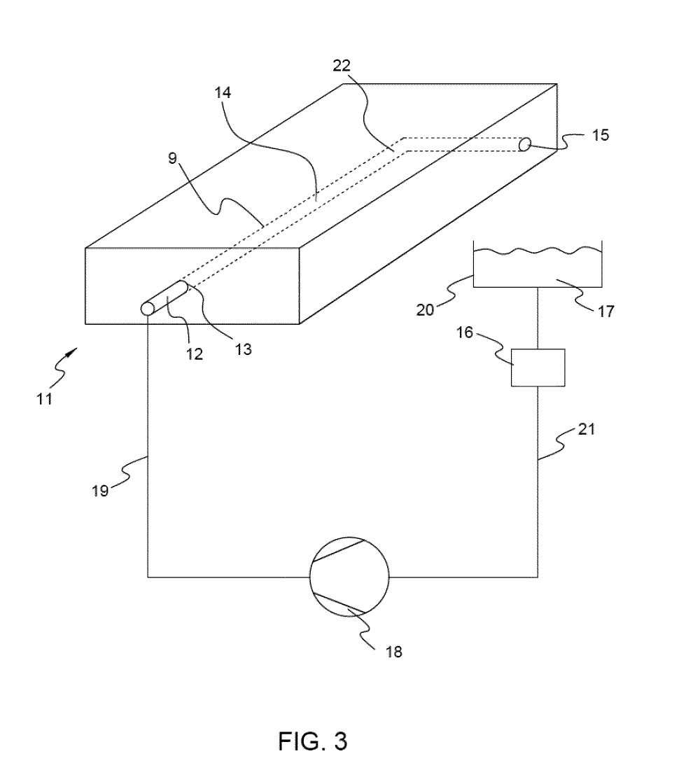

FIG. 3 shows an arrangement with a flushing device for removing the porous structure 22 from a cavity of an additively manufactured component.

A schematically illustrated three-dimensional component 11 has been manufactured by electron beam melting. The component 11 has a connection 12 which projects on its external side and is designed as a pipe socket and connected to a first aperture 13 serving as an inlet. The first aperture 13 opens into a cavity 14, which is surrounded by walls 9. The cavity 14 has a curved profile and opens at a second aperture 15 forming an outlet.

In the interior of the component 11, the cavity 14 has a porous structure 22 created during the manufacturing of the component 11. In order to remove the porous structure 22, a first line 19 of the flushing device is connected to the connection 12. Subsequently, by means of a pump 18, e.g. hydrochloric acid is pumped into the cavity 14 as a liquid etchant 17. The etchant 17 flows through the porous structure 22 and emerges at the second aperture 15. The etchant 17 is collected in a container 20, which is connected to the pump 18 via a second line 21. The etchant 17 is conveyed in a circuit. The flushing device comprises a filter 16 in which metallic powder particles and/or substructures of the disintegrated porous structure 22 that were removed from the cavity 14 are collected. The etchant 17 also performs a smoothing of the walls 9 of the cavity 14.

It is sufficient to allow the etchant 17 to act until approximately 5% by weight of the porous structure 22 has been dissolved. By means of the etchant 17, in particular the sinter necks 10 are at least partially dissolved, as a result of which the porous structure 22 disintegrates. After a predetermined duration of e.g. 5 minutes, the etchant 17 is removed and the cavity 14 is flushed with water. The water can be supplied via the pump 18.

After the dissolved powder particles and/or substructures have been flushed out, the integrally molded connection 12 is removed, e.g. by machining. The component 11 shown in FIG. 3 has only a single cavity 14. However, other embodiments are also possible in which a component has a plurality of such cavities or communicating cavity sections with a complex three-dimensional shape. The porous structures present in the interior of the component can be removed one after the other from the individual cavities or cavity sections by means of the described method, whereby an uncovered cavity or cavity section can then be temporarily closed.

By means of the described method, components with complex shaped cavity structures, such as turbine blades of a stationary gas turbine or an engine of an aircraft, can be manufactured with high precision and their cavities uncovered.

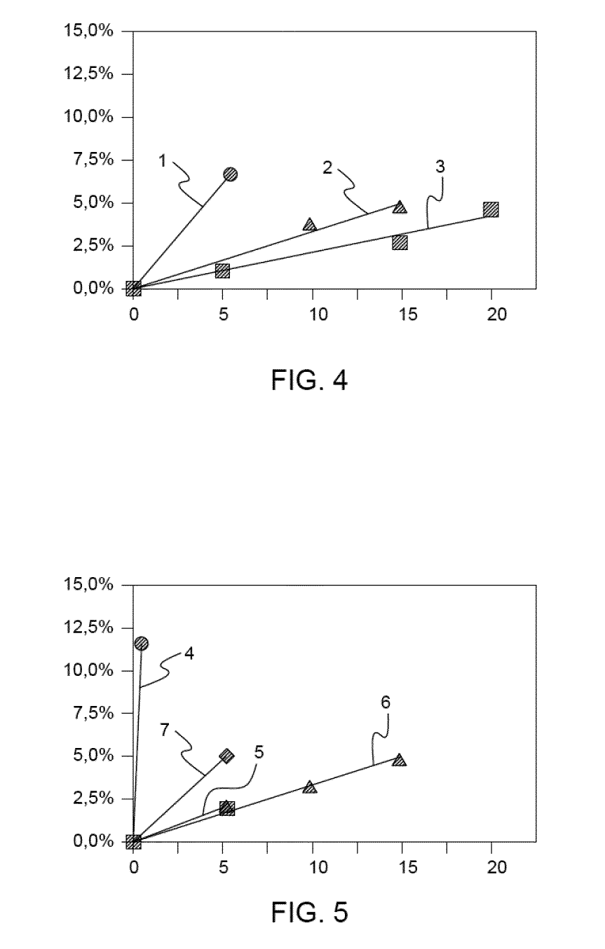

FIGS. 4 to 6 show diagrams of etching experiments on different materials. The horizontal axis is the time axis, while the vertical axis indicates the percentage mass loss.

FIG. 4 shows the results for a test specimen made of a nickel base alloy for three different etchants. The etchant designated by 1 has the composition 95% by volume HCl (32% conc.)+5% by volume H₂O₂ (30% conc.). The etchant designated by 2 has the composition 90% by volume HCl (32% conc.)+10% by volume H₂O₂ (30% conc.). The etchant designated by 3 has the composition 80% by volume HCl (32% conc.)+20% by volume H₂O₂ (30% conc.). Several experiments were performed with different etching times. It is shown that, when a suitable etchant is selected, disintegration of the porous structure can be achieved even after an etching time of less than 5 minutes.

FIG. 5 shows the effect of different etchants on a test specimen made of pure copper. The etchant designated by 4 is HNO₃ (65% conc.). The etchant designated by 5 is HNO₃ (6% conc.). The etchant designated by 6 is HNO₃ (15% conc.). The etchant designated by 7 is HCl (32% conc.). It can be seen that the effect of the etchant HNO₃ occurs more rapidly at higher concentrations.

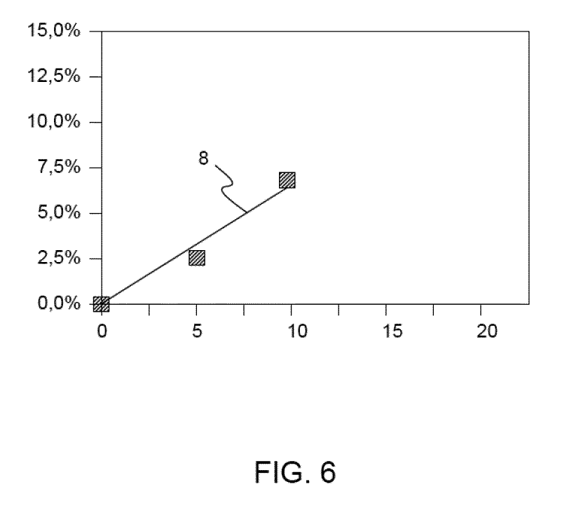

FIG. 6 shows the results of etching experiments on a test specimen made of the material TiAl6V4. The etchant designated by 8 is 25% KOH+10% H₂O₂ (30% conc.)+65% H₂O. A mass loss of about 5%, which is sufficient to remove the porous structures, is already reached after around 8 minutes.

FIGS. 4 to 6 show that the described method for removing porous structures can be performed rapidly and thus efficiently.

What we claim is:

1. A method according for the manufacturing of a component in which walls surround a cavity and the cavity is accessible through at least one aperture formed in one of the walls, the method comprising:
manufacturing of the component by an additive method in which metallic powder particles are applied in layers in a process chamber on a support, and the walls are manufactured each time after applying a layer of metallic powder particles by melting with an energy beam along a predetermined path;
connecting the aperture a flushing device;
feeding a liquid etchant into the cavity by means of the flushing device, using the etchant, selectively dissolving powder particles which are connected to each other only by way of sinter necks and/or fusible links; and
removing the etchant and the dissolved powder particles from the cavity.

2. The method according to claim 1, further comprising, during the manufacture of the component, forming a connection linked to the aperture for the detachable connection to a line of the flushing device.

3. The method according to claim 2, further comprising removing the connection after flushing the dissolved powder particles.

4. The method according to claim 1, wherein that the flushing device comprises a pump.

5. The method according to claim 1, further comprising collecting the dissolved powder particles in a filter of the flushing device.

6. The method according to claim 1, wherein that the etchant is conveyed through the flushing device in a circuit.

7. The method according to one of the preceding claims, further comprising feeding the liquid etchant into the cavity through a first aperture and flushed out through a second aperture of the component.

8. The method according to claim 1, removing successively dissolved powder particles from a plurality of cavity sections of the component, and an uncovered cavity section is preferably closed temporarily.

9. The method according to claim 1, wherein an electron beam or a laser beam is used as the energy beam.

10. The method according to claim 1, wherein metallic powder particles of a nickel base alloy, a cobalt base alloy, a titanium base alloy, a copper alloy, steel, titanium aluminides or a combination thereof are used.

11. The method according to claim 1, wherein at least one of the following substances or a combination thereof is used as the etchant:
Hydrochloric acid (HCl),
Hydrochloric acid (HCl)+hydrogen peroxide (H2O2),
Hydrochloric acid (HCl)+acetic acid (C2H4O2),
Acetic acid (C2H4O2)+perchloric acid (HClO4),
Hydrochloric acid (HCl)+hydrogen peroxide (H2O2),
Nitric acid (HNO3), preferably in the following concentrations: 65%, 15%, 6%,
Acetic acid (C2H4O2)+hydrochloric acid (HCl)+nitric acid (HNO3),
Nitric acid (HNO3)+acetic acid (C2H4O2)+phosphoric acid (H3PO4),
Nitric acid (HNO3)+hydrofluoric acid (HF),
Hydrofluoric acid (HF)+sulfuric acid (H2SO4),
Iron(III) nitrate (Fe(NO3)3)+acetic acid (CH3COOH)+water (H2O),
Iron(III) chloride (Fe(III)Cl3) saturated+hydrochloric acid (HCl)+nitric acid (HNO3),
Potassium hydroxide (KOH)+hydrogen peroxide (H2O2),
Potassium hydroxide (KOH)+hydrogen peroxide (H2O2)+water (H2O),
25% by volume of potassium hydroxide (KOH)+10% by volume of hydro-gen peroxide (H2O2)+65% by volume of water (H2O),
Sulfuric acid (H2SO4)+hydrochloric acid (HCl),
Nitric acid (HNO3)+hydrochloric acid (HCl)+hydrofluoric acid (HF), and
Sodium hydroxide (NaOH).

12. The method according to claim 1, further comprising bringing the powder particles, which form a porous structure and are only connected to one another via sinter necks, into contact with the etchant for a time of less than 1 minute to 20 minutes, and preferably 1 minute to 10 minutes.

13. The method according to claim 1, introducing the etchant into the cavity and/or remaining there until such time as 2 to 10% by weight, and preferably 5% by weight, of the porous structure formed by the powder particles connected only via their sinter necks is removed from the cavity.

14. The method according to claim 1, a part of a stationary gas turbine or an engine of an aircraft, in particular a turbine blade, is manufactured as the component.

15. A component, which is preferably designed as a gas turbine component and, in particular, as a turbine blade, has at least one cavity, and is manufactured by a method according to claim 1.
